(19) United States
(12) Patent Application Publication
(10) Pub. No.: US 2024/0115454 A1
(43) Pub. Date: Apr. 11, 2024

(54) WEARABLE ROBOT, SYSTEM AND METHOD FOR CORRECTING GAIT IMPAIRMENTS

(71) Applicant: IUVO S.R.L, Pontedera (PI) (IT)

(72) Inventors: Roberto CONTI, Pontedera (PI) (IT); Simona CREA, Pontedera (PI) (IT); Francesco GIOVACCHINI, Pontedera (PI) (IT); Chiara LIVOLSI, Pontedera (PI) (IT); Andrea PARRI, Pontedera (PI) (IT); Nicola VITIELLO, Pontedera (PI) (IT); Franco MOLTENI, Pontedera (PI) (IT); Eleonora GUANZIROLI, Pontedera (PI) (IT)

(21) Appl. No.: 18/269,040

(22) PCT Filed: Dec. 15, 2021
(86) PCT No.: PCT/IB2021/061787

§ 371 Date: Jun. 22, 2023

Related U.S. Application Data
(60) Provisional application No. 63/192,796, filed on May 25, 2021.
(60) Provisional application No. 63/129,039, filed on Dec. 22, 2020.

(51) Int. Cl. A61H 1/02

(52) U.S. Cl. CPC A61H 1/0244; A61H 2201/1628; A61H 2201/165; A61H 2201/5061

(57) ABSTRACT

A wearable robot, system and method are provided for correcting gait impairments, such as knee hyperextension, in a user. The wearable robot is an assistive lower-limb exoskeleton having a frame and an actuation system to generate an assistive force with timing, duration, and amplitude based on a gait impairment mitigation strategy.

### FIELD OF THE DISCLOSURE

A wearable robot, system and method are provided for correcting gait impairments, such as knee hyperextension, in a user. The wearable robot is an assistive lower-limb exoskeleton having a frame and actuation system to generate an assistive force with timing, duration, and amplitude based on a gait impairment mitigation strategy.

### BACKGROUND

Gait disorders and lower-limb impairments due to aging and pathological conditions, such as neurological and musculoskeletal diseases, are among the more significant causes of restricted life and personal independence loss. As a matter of example of gait impairments, knee hyperextension is a very common problem in people affected by neurological disorders where damage to neural pathways cause weakness or losing control about the knee joint, such as stroke, multiple sclerosis, cerebral palsy, muscular dystrophy, spinal cord injury, etc., or in people affected by deformity or damage in the knee.

The knee joint's normal range of motion is from 0° to 135° in an adult, and full knee extension should generally be no more than 10° in a normal gait cycle. Hyperextension in the knee joint is generally characterized by an increase in full knee extension during a stance phase of the gait cycle, which may be mild, moderate, or severe, limiting mobility by disrupting an individual's balance and gait pattern and leading to other pathologies, including the development of asymmetric gait patterns, pain, osteoarthritis, damage to tendons or ligaments, etc.

The ability to walk is held as an important goal in the treatment of any neurological disorder, as this basic ability not only facilitates independent living and its associated psychological benefits but also leads to increased patient compliance in other treatment regimes, increases muscle strength, improves cardiovascular fitness, and can assist in the restoration or maintenance of cognitive function. Both treatments for underlying causes of knee hyperextension and corrective measures for chronic knee hyperextension are highly desired.

Conventional treatment of knee hyperextension generally relies on gait training to optimize walking performance. Gait training is primarily focused on leading a patient through the practice of individual components of a gait cycle, such as by direct intervention and coaching from a trained clinician or assisted practice using specialized treadmills and biofeedback devices to guide the patient. While often successful over a long-term treatment course, gait training requires regular, monitored training sessions, possibly over the years, before any improvement. Outside of these relatively limited periods of direct clinical intervention and training, patients can be left with the negative effects of immobility and knee hyperextension, possibly extending the time needed for successful therapy.

Braces, walkers, and other orthotic devices have been employed as corrective measures for “outside the lab” daily use to meet real-life demands on a patient with knee hyperextension. For example, a rigid brace may be designed for mechanically limiting the range of motion of the knee joint and preventing hyperextension by forcefully stopping rotation at a given point. Other braces have been designed with elastic elements to elastically respond to hyperextension in the knee by more gradually reducing hyperextension.

While some success in mitigating the effects of knee hyperextension on the gait cycle has been found with these devices and associated methods, the assistance provided to the knee joint cannot be fined tuned to the particular needs of the patient (e.g., weight, strength level, spasticity levels, and other gait impairments) and cannot replicate the gradual progress of a natural gait cycle. The intervention achieved in conventional corrective measures is generally abrupt and reactive, such that conventional corrective measures only intervene by resisting hyperextension when it has begun or otherwise negatively affect other portions of a user's gait cycle. Known corrective measures cannot replicate the comfort and stability of natural movement. Significant challenges remain in designing a treatment or corrective strategy that realizes a more natural gait and can contribute to clinical gait training efforts.

From the preceding, a need exists for methods and systems capable of correcting gait impairments, such as knee hyperextension, i.e., by mimicking a natural gait pattern. There is further a need for methods and systems of correcting gait impairments finely adjustable to the characteristics of an individual user and that can dynamically prevent hyperextension in the knee and other gait impairments, using a single device or by providing an assistive torque at a single joint for correcting an impairment of another joint. As a matter of example, correction of knee hyperextension provides a more natural and comfortable gait. Further gait training benefits may result, improving patient compliance, and reducing the time needed to achieve improvements through gait training.

### SUMMARY

It is an object of the disclosure to provide improved methods and systems for correcting gait impairments, such as knee hyperextension, in a user. An object of the disclosure is to dynamically counteract hyperextension of the knee by applying an assistive force on a hip level for correcting a knee pattern, based on individual characteristics of the user.

According to the disclosure, a system and method for correcting knee hyperextension with a wearable robot or more specifically an assistive lower-limb exoskeleton arranged to provide a new assistive strategy for correcting knee hyperextension, capable of assisting the real needs of a user by enabling a more natural gait. The correction of knee hyperextension is based on providing an assistive force to the user's limb during a stance phase of the gait cycle. Flexion assistance may be provided at a user's hip joint, i.e., to a thigh, during the stance phase to counteract the knee's hyperextension.

Wearable robots are provided to assist in movement and restore functional gait patterns and represent technical aids to support daily-life scenarios. In the context of this disclosure, a wearable robot is a powered or passive exoskeleton. In a powered exoskeleton, the wearable robot is a machine that is powered by a system of electric motors, pneumatics, levers, hydraulics, or a combination of technologies that allow for limb movement with increased strength and endurance. Some wearable robots sense the user's motion, and send a signal to manage movement of the wearable robot. The wearable robot can be arranged to secure, support or move the shoulder, waist and thigh, and can assist movement for lifting and holding heavy items. In a passive exoskeleton, the exoskeleton is not powered however it can provide mechanical benefits to the user. Wearable robots can improve rehabilitation programs of people with limb impairments and ambulatory conditions by providing coordinated assistance in limbs' movement.

With assistive devices for people with mild lower-limb impairments, wearable robots can be relied on to assist in the lower limbs' active movement by generating an appropriate force for advancing a portion of the limbs in a gait cycle, for example, by initiating a swing phase. Intervention by the wearable robots is conventionally limited to supporting these active movements to achieve a natural gait and, as forward movement of the limb is limited in a stance phase, irregularities in a stance phase of the gait cycle rely on similar concepts as known in conventional braces and walkers to treat knee hyperextension.

More specifically, existing braces, walkers, orthotic devices, and assistive devices are single-joint devices configured for providing assistance or correction to the specific assisted joint, by providing torque induces a more physiological pattern of that joint. These devices require the application of force or resistance to the assisted joint directly and located at the assisted joint. Existing devices require distinct devices to treat each joint involved in gait impairment.

The assistance provided to the limb may be tuned to characteristics of the individual user (e.g., weight, strength level, spasticity levels, and other gait impairments) by adjusting at least the timing of the flexion assistance, the duration of the flexion assistance, or the amplitude of the flexion assistance. According to the disclosure, the timing of the flexion assistance may be defined as a central position of flexion assistance profile in a gait cycle, or stride, measured from 0 to 100%, the duration of the flexion assistance may be defined as a width of the flexion assistance profile, in percent, of the gait cycle, and the amplitude of the flexion assistance may be defined as a peak level of assistive flexion torque provided to the user's limb during the flexion assistance.

According to an embodiment, the system and method may comprise determining flexion assistance by identifying hyperextension of a user's knee during a gait cycle, determining the flexion assistance's timing, determining the flexion assistance duration, and determining an initial amplitude of the flexion assistance. Following the flexion assistance determination, the method may comprise applying an assistive force to a limb of the user according to the flexion assistance.

According to the flexion assistance, the application of the assistive force may advantageously correct an impairment in the knee joint of the user from the hip level. In the flexion assistance profile, an assistive torque at the hip or thigh may gradually increase in parallel with the growing load on the knee during the gait cycle, gradually decreasing as the load on the knee wanes. The fine-tuning of the assistive torque at the hip joint about timing, duration, and amplitude advantageously enables gradual, anticipatory correction of knee hyperextension rather than abrupt, reactionary corrections as known in the prior art.

In conventional correction measures for knee hyperextension, a range of motion of the knee may be limited by a brace or other means directly at the knee joint, or a reactionary force may be provided about the knee joint in response to active hyperextension. These corrective measures result in halting or stuttering interruptions in a natural gait cycle, leading to discomfort or losing balance for the user while also preventing the user from practicing a normal gait. In contrast to the methods of the prior art, applying an assistive force at the hip level according to the flexion assistance profile of the disclosure corrects knee hyperextension by effectively canceling out a portion of the load on the knee joint that causes hyperextension as it occurs, advantageously restoring a natural gait of the user. The systems, methods and devices of the disclosure further allow for a blending of assistive profiles for a plurality of joints, such that assistance at the hip level may correct gait impairments at one or all of a hip, knee or ankle joints.

The timing of the flexion assistance may be coordinated to the user's particular needs by matching the timing of the flexion assistance to an identified timing of the hyperextension of the knee or to a timing of a middle region of a stance phase of the gait cycle. For example, the timing of the flexion assistance may be within a range of 15% to 40% of the gait cycle, particularly 20% to 35% of the gait cycle, or more particularly 25% to 30% of the gait cycle and may be fine-tuned to the specific needs and characteristics of the user.

The duration of the flexion assistance may comprise 10% to 55% of the gait cycle, particularly 20% to 35% of the gait cycle, or more particularly 25% to 30% of the gait cycle and may be fine-tuned to the specific needs and characteristics of the user. The amplitude of the flexion assistance may be within a range of 1.0 N*m to 4.0-N*m, particularly 1.5 N*m to 2.5 N*m, or more particularly 1.75 N*m to 2.25 N*m and may be fine-tuned to the specific needs and characteristics of the user.

In an embodiment, the system and method may comprise iterative steps for determining an individualized flexion assistance for a user. Advantageously, the flexion assistance may be provided at a different joint than the gait impairment source. Steps of the method may include identifying a first hyperextension of the user's knee during a gait cycle, determining the first timing for first flexion assistance, determining a first duration of the first flexion assistance, and determining a first amplitude of the first flexion assistance. Following the determination of the first flexion assistance, the method may comprise applying an assistive force to a limb of the user according to the first flexion assistance, for example, at the hip or thigh.

During the assistive force application according to the first flexion assistance, the method may further comprise identifying a non-corrected hyperextension of the user's knee (called second knee hyperextension to distinguish it from the initial one) or an induced knee flexion during a stance phase of the gait cycle (meaning that the flexion assistance is too high) as may require further fine-tuning of the assistive force. If the second knee hyperextension is identified, the method may increase the amplitude of second flexion assistance relative to the first flexion assistance and apply an assistive force to a limb of the user according to the modified second flexion assistance. On the other hand, if the induced knee flexion during the stance phase is identified, the method may decrease the amplitude of the second flexion assistance relative to the flexion assistance and apply an assistive force to a limb of the user according to the modified second flexion assistance.

During the assistive force application according to the second flexion assistance, the method may further comprise identifying a non-corrected hyperextension of the user's knee (called third knee hyperextension to distinguish it from the initial one) or an induced knee flexion during the stance phase of the gait cycle (meaning that the flexion assistance is too high) such as may require further fine-tuning of the assistive force. If the third knee hyperextension is identified, the method may comprise adjusting the timing of third flexion assistance relative to the first or the second flexion assistance and applying an assistive force to the user's limb according to the modified third flexion assistance. On the other hand, if the induced knee flexion during the stance phase is identified, the method may decrease the amplitude of the third flexion assistance relative to the first or the second flexion assistance and apply an assistive force to a user's limb to the modified third flexion assistance.

According to varying embodiments, the method may include iteratively repeating the above steps, for example, for determining a fourth, a fifth, or any other flexion assistance by increasing or decreasing the amplitude of the torque profile, by adjusting the timing of the flexion assistance, or by adjusting the duration of the flexion assistance. By iteratively detecting knee hyperextension or knee flexion during a stance phase and adjusting the amplitude, timing, or the duration of the flexion assistance based on the detecting, the resulting individualized flexion assistance is advantageously finely tuned to the characteristics and needs of the user.

An exemplary wearable robot for performing the method and/or forming part of the system may comprise an active pelvis orthosis (APO) having an actuation system arranged to assist bilateral hip flexion/extension movements transmitted by first and second leg units. The APO may include a trunk from which the actuation system extends to at least one hip joint, the at least one hip joint corresponding to at least one leg unit. The APO preferably includes a power unit and a computing unit. The power unit is preferably arranged to provide assistive power to the actuation system for driving at least one leg unit at the hip joints based on the computing unit's assistance profile. The assistance profile may include flexion assistance for correcting knee hyperextension of a user.

The flexion assistance of the assistance profile may be determined according to methods of the disclosure. In embodiments, the computing unit may be configured for determining a timing for the flexion assistance, duration of the flexion assistance, and an amplitude of the flexion assistance for the assistance profile based on the identification of a knee hyperextension during a stance phase. The computing unit may be connected to at least one sensor for identifying a knee hyperextension or a knee flexion during a stance phase. The computing unit automatically determines timing for the flexion assistance, duration of the flexion assistance, and an amplitude of the flexion assistance for the assistance profile.

Following determination of the flexion assistance, the computing unit may be configured for controlling the actuation system for driving at least one leg unit at the hip joints based on the assistance profile, including the flexion assistance.

The assistance profile may include additional flexion and/or extension assistance, as contemplated by one skilled in the art to assist in movement and to restore functional gait patterns by providing coordinated assistance in the movement of limbs, in addition to the flexion assistance for correcting knee hyperextension according to the current disclosure. For example, the computing unit may be configured for determining segmentation and/or gait events of a gait cycle of a user based on input from the at least one sensor and applying an assistive force to a limb of the user according to the first flexion assistance and according to an assistive force for advancing a portion of the limbs in a gait cycle, by initiating a swing phase.

The computing unit may further be configured for providing feedback to the user or a clinician by actively evaluating knee hyperextension using the at least one sensor. In embodiments, the computing unit may be arranged to present gait training to the user by incremental reductions in the duration and/or amplitude of the flexion assistance, such as based on the feedback determined by the computing unit.

The above embodiments, systems and methods solve the problem of existing systems and methods for correcting knee hyperextension, including braces, walkers, and other orthotics with only limited tunability and only capable of reacting to impairment at a single joint by providing improved gait assistance with increased adjustability and effectiveness. These and other present disclosure features will become better understood regarding the following description, appended claims, and accompanying drawings.

### BRIEF DESCRIPTION OF THE DRAWINGS

FIG. 1 is an exemplary illustration, and the corresponding chart exemplifying a gait cycle, including a stance phase and a swing phase segmented at heel strike and toe-off stages.

FIG. 1A is a chart showing an exemplary hip Assistive Profile (hAP).

FIG. 2 is an exemplary illustration exemplifying a gait cycle exhibiting knee hyperextension in a paretic limb, including a stance phase and a swing phase.

FIG. 3 is a simplified diagram of hyperextension in a knee joint.

FIG. 4 is a graphical representation plotting an angle of a knee joint against the duration of a gait cycle for a user exhibiting knee hyperextension.

FIG. 5 is a simplified diagram of a method for correcting knee hyperextension according to an embodiment of a system and/or a method of the disclosure.

FIG. 6 is a graphical representation illustrating a user wearing a schematic wearable robot during a stride above the plot of different possibilities of assistive profiles having different timings against mean and standard deviation of a hip joint angle.

FIG. 7 is a flowchart illustrating a method for correcting hyperextension of a knee joint according to an embodiment of the disclosure.

FIG. 8 is a graphical representation plotting an angle of a knee joint against the duration of a gait cycle for a user having knee hyperextension corrected according to an embodiment of a system and/or a method of the disclosure.

FIG. 9 is a flowchart illustrating a method for correcting hyperextension of a knee joint according to an embodiment of the disclosure.

FIG. 10a is a perspective view illustrating an exemplary wearable robot arranged as an Active Pelvis Orthosis.

FIG. 10b is a perspective view illustrating an exemplary wearable robot arranged as Active Pelvis Orthosis having an open shell.

FIG. 11 is a schematic categorizing different gait impairments and guidelines for designing assistance.

FIG. 12 is a block diagram of a tuning procedure for defining a tailored assistance according to specific gait impairments according to FIG. 11.

FIG. 13 is a schematization of a gait cycle in seven subphases: loading response, midstance, terminal stance, pre-swing, initial swing, mid swing and terminal swing.

FIGS. 14A and 14B illustrate the selection of assistive primitives according to Step 1 in the Tailored hip Assistive Profile (T-hAP) of the system and method thereof.

FIG. 15 illustrates the identification of the biomechanical gait cycle sub-phases in a user's hip angular profile according to Step 2 in the system and method thereof.

FIG. 16 illustrates the identification of the assistance primitives into a user's gait cycle subphases and the shaping of the T-hAP in terms of timing according to Steps 3 and 4 in the system and method thereof.

FIG. 17 illustrates the identification of the shaping of the T-hAP in terms of the duration according to Step 5 in the system and method thereof.

FIG. 18 illustrates the identification of the shaping of the T-hAP in terms of amplitude according to Step 6 in the system and method thereof.

The drawing figures are not necessarily drawn to scale, but instead, are drawn to provide a better understanding of the components, and are not intended to be limiting in scope, but to provide exemplary illustrations.

### DETAILED DESCRIPTION

A better understanding of different embodiments of the invention may be had from the following description read with the accompanying drawings in which like reference characters may refer to like elements.

While the disclosure is susceptible to various modifications and alternative constructions, certain illustrative embodiments are shown in the drawings and will be described below. It should be understood, however, there is no intention to limit the disclosure to the embodiments disclosed, but on the contrary, the intention is to cover all modifications, alternative constructions, combinations, and equivalents falling within the spirit and scope of the disclosure and defined by the appended claims.

It will be understood that, unless a term is defined in this patent to possess a described meaning, there is no intent to limit the meaning of such term, either expressly or indirectly, beyond its plain or ordinary meaning.

According to various embodiments, the system and method for correcting gait impairments with a wearable robot or assistive lower-limb exoskeleton, such as an Active Pelvis Orthosis (APO), provides a new assistive strategy for correcting knee hyperextension, capable of providing tailored assistance based on the real needs of a user, for example, to allow a more natural gait. The correction of knee hyperextension may be based on providing an assistive force to the user's limb during a stance phase of the gait cycle. Flexion assistance may be provided at hip level, i.e., at a thigh, during the stance phase to counteract hyperextension of the knee.

Although the exemplary embodiments of the disclosure are shown and described for correcting knee hyperextension based on providing an assistive force to the user's limb during a stance phase of the gait cycle, the embodiments of the disclosure may also be adapted to correct different gait impairments, including stance impairments and swing impairments. For example, the principles of a system and method for correcting hyperextension of a knee joint according to an assistive flexion torque may be adapted to a system and method for correcting buckling of a knee joint according to an assistive extension torque having an extension assistance or profile. Further, a final assistance provided for different gait impairments may be the sum of different proposed assistive profiles, such that application of assistive torque at a single joint may address gait impairments at other joints.

The embodiments of the disclosure are not limited to hip exoskeletons but may be applied to any robotic joints where it is necessary to correct a gait phase or event, such as in robotic joints relating to assisting lower-limb physiological joints, as understood from the disclosure by one of ordinary skill in the art.

An APO provides flexion/extension torques at hip joints with precise timing and duration, referred to as hip Assistive Profile (hAP), during over ground walking exercises and in a dynamic condition. An APO is able to improve one or more gait determinants in user affected by gait disorders (e.g., lower-limb amputees or user with neurological disorders such as stroke victims post stroke) due to the ability to tailor the hAP.

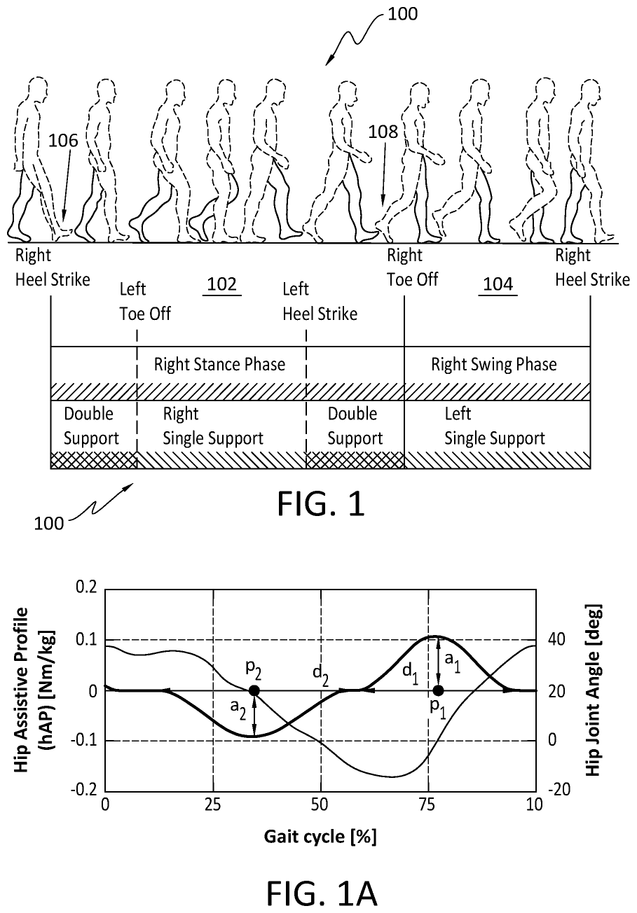

As shown in FIG. 1A, the APO hAP is a torque versus gait cycle curve characterized by parameters corresponding to amplitude (a), phase (p) and duration (d) (a_{flexion} or a₁, p_{flexion} or p₁, d_{flexion} or d₁, aₑₓₜₑₙₛᵢₒₙ or a₂, pₑₓₜₑₙₛᵢₒₙ or p₂, and dₑₓₜₑₙₛᵢₒₙ or d₂). These parameters define the position of two torque bells in specific percentage of the gait pattern of the user, and their duration and amplitude. The similar characterizations of amplitude (a), phase (p) and duration (d) are applied to FIGS. 14A, 14B and 16-18.

For each user, there is the problem of determining the most effective hAP (i.e., torque versus gait cycle) to be provided at the user's hip, with the main objectives of: (1) mitigating gait impairment effects in different joints (i.e., hip, knee and ankle); and/or (2) improving functional outcomes (i.e., walking speed, stability and symmetry) of the user. When considering the neurological disorders of a population, such as for stroke recovery, there is a large variability of residual conditions in the users in terms of gait impairment, spasticity, weakness, etc., which complicates the ability to determine the most effective hAP for an individual.

According to this disclosure, an improved and effective action of the hAP (torque vs. gait cycle) to be provided on a user's hip, in order to mitigate hip, knee, ankle and gait impairments is referred to a Tailored hip Assistive Profile (T-hAP). In embodiments, systems and methods described herein, an improved solution is provided for allowing the identification of T-hAP for a specific user; and providing such T-hAP for the user.

To ease understanding the disclosed embodiments of a system and method for correcting knee hyperextension, a description of a few terms may be useful. The biomechanical and anatomical terms described are not intended to detract from the normal understanding of such terms as readily understood by one of ordinary skill in the art of locomotion.

The embodiments of the system and method for correcting knee hyperextension may be described in relation to a gait cycle, defined as the period and sequence of events or movements during locomotion in which one-foot contacts the ground to when that same foot again contacts the ground. A single gait cycle 100, or stride, of a healthy individual, is illustrated in FIG. 1 about temporal parameters segmenting the gait cycle at heel strike and toe-off of both legs, right and left.

Each gait cycle has two phases: the stance phase 102 and the swing phase 104. The stance phase 102 is the period when the foot is in contact with the ground. The swing phase 104 is the period when the foot is not in contact with the ground. In those cases where the foot never leaves the ground (foot drag), the swing phase 104 can be defined as the phase when all portions of the foot are in forward motion. As shown in the exemplary illustration of FIG. 1, the stance phase 102 generally occupies 60% of the gait cycle 100, and the swing phase 104 generally occupies 40% of the gait cycle 100.

Periods of double support during the stance phase 102 of the gait cycle 100 (both feet are simultaneously in contact with the ground) give way to two periods of a double float at the beginning and the end of the swing phase of gait (neither foot is touching the ground). The periods of double support generally occupy 20% of the gait cycle. Single support is the period when only one foot is in contact with the ground. In walking, this is equal to the swing phase of the other limb.

FIG. 1 shows heel strike 106 as the event signaling the initial contact phase. Initial contact comprises the brief period that begins when the foot touches the ground and is the first phase of double support. Heel strike 106 and initial contact comprises 30° flexion of the hip with full extension in the knee, and the ankle moves from dorsiflexion to a neutral position then into plantar flexion. The normal range of motion of the knee joint is from 0° to 135° in an adult, and full knee extension should generally be no more than 10° in a normal gait cycle.

After this, knee flexion (5°) increases, as the plantar flexion of the heel is increased. Plantar flexion is allowed by eccentric contraction of the tibialis anterior, and a contraction of the quadriceps causes the knee extension. A contraction of the hamstrings causes flexion, and the contraction of the rectus femoris causes flexion of the hip. Toe off 108 occurs when terminal contact is made with the toe. The hip becomes less extended, and the knee is flexed often 35-40°, and the toes leave the ground.

Hyperextension in the knee joint is generally characterized by an increase in full knee extension during the knee joint loading in the stance phase 102 of the gait cycle 100. The hyperextension may be mild, moderate, or severe, depending on the magnitude of associated ligamentous deficiencies, quadriceps muscle atrophy or weakness, ankle plantar flexion spasticity, heel cord contracture, gastrocnemius-soleus weakness, symptomatic patellofemoral arthritis, etc.

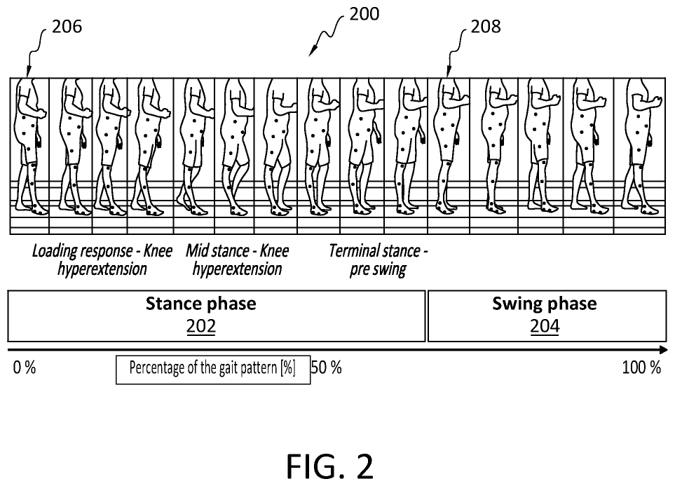

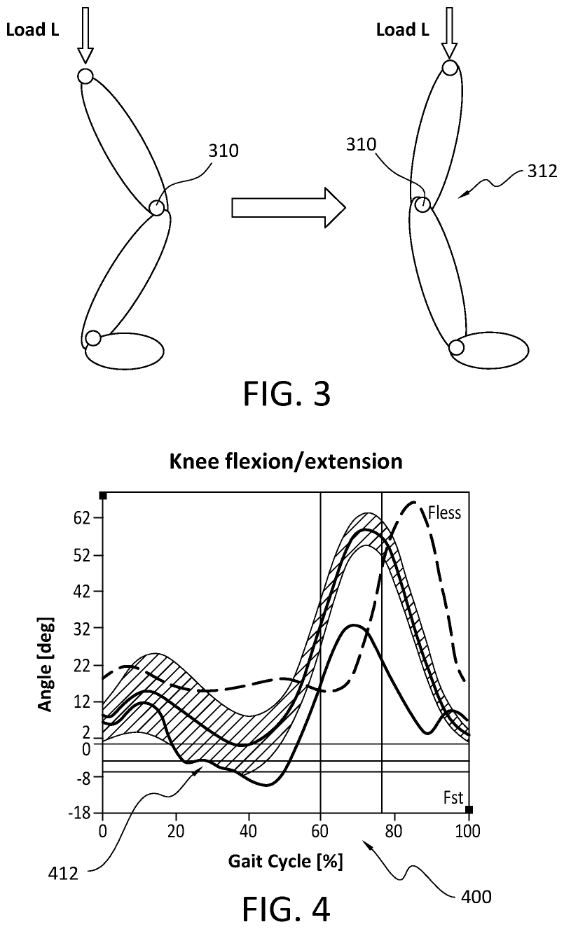

FIG. 2 illustrates an example of knee hyperextension of a paretic limb, such as a limb having slight or partial paralysis, in a gait cycle 200. During heel strike 206 (or initial contact) of a stance phase 202, instability at a knee joint causes the knee to “snap” backward into hyperextension under the load L of bodyweight moving forward over the limb, particularly over a knee joint 310 of the limb, as diagrammed in FIG. 3. The hyperextension 312 of the knee joint 310 may comprise a range of knee extension from 10° to 20°, or greater, and can continue from the heel strike 206 to toe-off 208, or until knee flexion in the swing phase 204 returns the knee joint to no more than 10° extension.

FIG. 4 illustrates a graphical representation plotting an angle of a knee joint extension/flexion against the duration of a gait cycle 400 for a patient having a paretic side, resulting in knee hyperextension during a stance phase of a paretic limb. As shown, hyperextension 412 of the knee joint in this patient begins between 25% and 30% of the gait cycle, resulting in the extension of the knee joint to nearly 15°.

Embodiments of the system and method for correcting knee hyperextension are described for providing tailored assistance based on needs of a user. The embodiments of the system and related methods for correcting knee hyperextension according to the present disclosure advantageously allow a more natural gait by providing an assistive force to the user's limb at a hip level during a stance phase of the gait cycle to counteract hyperextension of the knee, and the same principles apply for correcting gait impairments of other joints as would be understood from the disclosure by one skilled in the art.

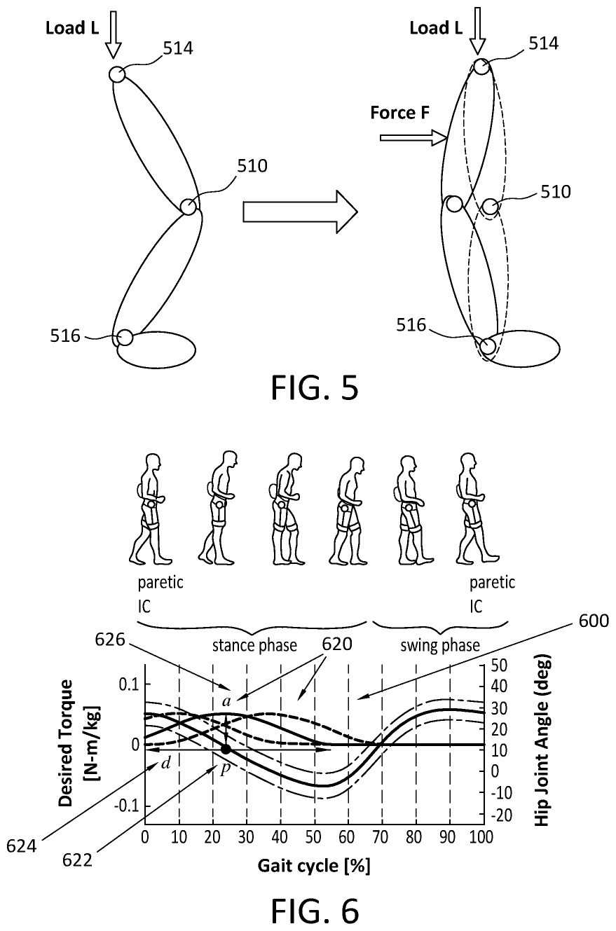

An embodiment of a method for mitigating or correcting knee hyperextension in a user is illustrated in the simplified diagram of FIG. 5. In the method, force F is applied to counteract knee hyperextension as the load L moves forward over the knee joint 510 of the limb, the force F preventing hyperextension of the knee joint 510 between a hip 514 and an ankle 516. The force F may be generated by providing an assistive flexion torque at the hip 514 through thigh links during a stance phase and may increase and decrease with changes in the load applied to the knee joint 510 during the stance phase, the assistive torque forming flexion assistance in an assistance profile. While the assistive torque does not match the biological torque of the assisted joint, i.e., the hip, the assistive torque may be tailored to correct gait impairments in the knee, reducing the need for additional sensors and systems for correcting a user's gait.

An example of an assistance profile 600 is illustrated in FIG. 6, showing assistive assistance versus % gait cycle. As shown, flexion assistance 620 may be characterized by timing 622, duration 624, and amplitude 626. The timing 622 may be defined as the % gait cycle at half duration of the flexion assistance 620. The duration 624 may be defined as the % gait cycle from the initial application of assistive torque to the conclusion of the assistive torque application. The amplitude 626 may be defined as the maximum value of the assistive torque 620.

The flexion assistance 620 may have a symmetrical bell-shaped, or gaussian shape, where the amplitude 626 defines the height of the curve's peak, the timing 622 defines the position of the center of the peak, and the duration 624 defines the width of the curve. Advantageously, flexion assistance may be increased and decreased at a changing rate as the gait cycle proceeds, allowing the assistive torque to follow the natural profile of a load on the knee joint.

According to embodiments, flexion assistance profile's shape and slope may be configured to be different according to the varying characteristics and needs of a user or abilities of an assistive torque generating device. For example, flexion assistance profile may be asymmetrical, having a left or right lean or skew such that timing and an amplitude of the flexion assistance occur at different points along the gait cycle. A slope of a side of flexion assistance profile might be constant, according to the needs of the user and abilities of the assistive torque generating device, such that a rate of increasing or decreasing assistive torque may vary during different periods or be held constant. For example, the flexion assistance profile may form a curved peak, a triangular peak, or another variation with a peak, or local maximum.

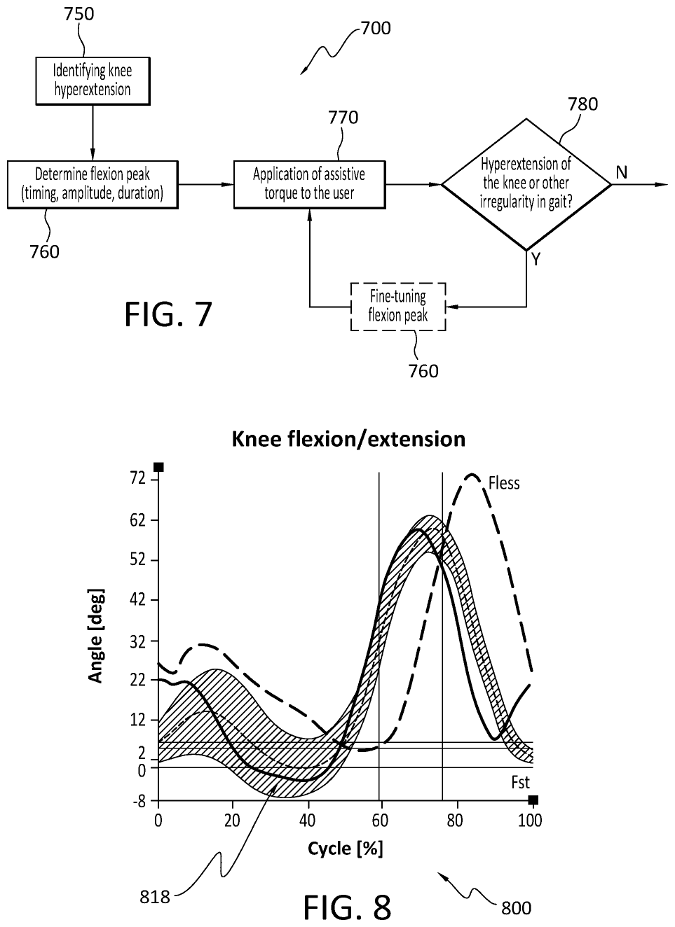

In the embodiment of a method according to FIG. 7, method 700 may comprise identifying hyperextension 750 of a user's knee during a gait cycle and determining parameters of flexion assistance 760, including a timing for the flexion assistance, a duration of the flexion assistance, and an initial amplitude of the flexion assistance, based on the identified hyperextension of the user's knee.

The timing of the flexion assistance may be coordinated to the user's particular needs by matching the timing of the flexion assistance to an identified timing of the hyperextension of the knee or a timing of a middle region of a stance phase of the gait cycle. For example, the timing of the flexion assistance may be within a range of 15% to 40% of the gait cycle, particularly 20% to 35% of the gait cycle, or more particularly 25% to 30% of the gait cycle and may be fine-tuned to the specific needs and characteristics of the user.

The duration of the flexion assistance may comprise 10% to 55% of the gait cycle, particularly 20% to 35% of the gait cycle, or more particularly 25% to 30% of the gait cycle and may be fine-tuned to the specific needs and characteristics of the user. For example, the duration of the flexion assistance may be tuned based on clinical evaluation of spasticity or flaccidity of a paretic limb during a stance phase; the more a limb is characterized by spastic contractions, the more the flexion assistance should be smooth, gentle, and then longer, to avoid eliciting spastic contractions.

The amplitude of the flexion assistance may be within a range of 1.0 N*m to 3.0 N*m, particularly 1.5 N*m to 2.5 N*m, or more particularly 1.75 N*m to 2.25 N*m and may be fine-tuned to the specific needs and characteristics of the user (e.g., by applying flexion assistance in N*m/kg of a user). In an example, the amplitude of the flexion assistance may be tuned based on a severity of the knee hyperextension (i.e., severe, moderate or mild) and the user's body weight. The amplitude may be determined for an average or normal gait velocity or may be further adjusted on the user's gait velocity and the severity of the knee hyperextension and body weight, either iteratively or in real-time.

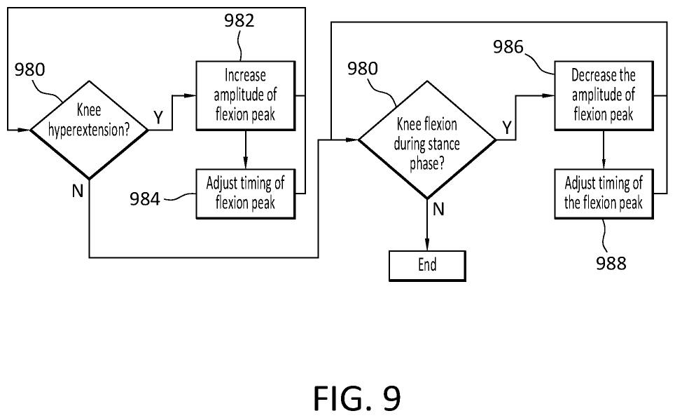

Following the determination of the flexion assistance 760, the method may comprise applying an assistive torque to a limb of the user 770 according to the determined flexion assistance to correct hyperextension. A corrected gait cycle may be reevaluated to identify any remaining knee hyperextension or irregularity 780, such as irregular knee flexion during the stance phase. The timing, the amplitude or the duration of the flexion assistance may be adjusted in a fine-tuning step 790 to minimize any remaining knee hyperextension or irregularities, as described in the embodiment of FIG. 9.

While known hip orthoses provide flexion torque during the swing phase and an extension torque during the stance phase, replicating the hip physiological torque pattern, the flexion assistance of the disclosure may be applied by a hip orthosis to provide hip flexion torque during the stance phase (which corresponds to the extension phase of the hip). It has now been discovered that embodiments of the disclosure mitigate knee hyperextension by providing torque at the hip level (therefore without acting directly on the joint that shows the pathological sign). Before the disclosure, it was not considered possible to act on the hip to correct a specific knee pathological sign. Advantageously, embodiments of the disclosure allow for correction of gait impairments from a single location, such as correction of knee hyperextension from the hip, increasing ease of use and reducing the number and extent of sensors, actuators, braces, etc., required for gait correction.

Some benefits of the described method are illustrated in FIG. 8, where a graphical representation plotting an angle of a knee joint against the duration of a gait cycle 800 for a user having knee hyperextension corrected according to an embodiment of a system and/or a method of the disclosure is provided. In this example, a method of the disclosure, according to FIG. 7 was used to determine flexion assistance and apply an assistive force to the user of FIG. 4.

FIG. 8 illustrates an example of knee flexion/extension of a gait cycle 800 for a patient having a paretic side, where an assistive force is applied having flexion assistance according to a method of the disclosure. In contrast to the unassisted gait cycle 400 of FIG. 4 exhibiting hyperextension 412, the gait cycle 800 having the assistance of flexion assistance according to the disclosure results in a normal physiological extension 818 of the knee during the stance phase of the paretic limb, around 5°, evidencing that the knee hyperextension has been corrected and a natural gait restored to the user.

In an embodiment according to FIG. 9, methods of the present disclosure may comprise iterative steps for determining individualized flexion assistance for a user during a fine-tuning step, such as the fine-tuning step 790 of FIG. 7. As in method 700 of FIG. 7, the method 900 may include similarly identifying a first hyperextension of the user's knee during a gait cycle 750, determining the first timing for first flexion assistance, determining a first duration of the first flexion assistance, and determining a first amplitude of the first flexion assistance. Following the determination of the first flexion assistance 760, the method may comprise applying an assistive force to a limb of the user according to the first flexion assistance 770.

During application of the assistive force according to the first flexion assistance, the method may further comprise identifying a second hyperextension of the user's knee or a first knee flexion during a stance phase of the gait cycle 780, 980, such as may require further fine-tuning of the assistive force. The second knee hyperextension is identified. The method may comprise increasing the amplitude of second flexion assistance relative to the first flexion assistance 982 and applying an assistive force to the user's limb according to the modified second flexion assistance. The first knee flexion during the stance phase is identified. The method may decrease the amplitude of the second flexion assistance relative to the first flexion assistance 986 and apply an assistive force to a limb of the user the modified second flexion assistance.

During application of the assistive force according to the second flexion assistance, the method may further comprise identifying a third hyperextension of the user's knee or a second knee flexion during the stance phase of the gait cycle 980. The third knee hyperextension is identified. The method may comprise adjusting the timing of a third flexion assistance relative to the first or the second flexion assistance 984 and applying an assistive force to a limb of the user the modified third flexion assistance. The second knee flexion during the stance phase is identified. The method may comprise decreasing the amplitude of the third flexion assistance relative to the first or the second flexion assistance 988 and applying an assistive force to a limb of the user according to the modified third flexion assistance.

According to varying embodiments, the method may include iteratively repeating the above steps, for example, for determining a fourth, a fifth or any other flexion assistance by increasing or decreasing the amplitude of the flexion torque, by adjusting the timing of the flexion assistance, and/or by adjusting the duration of the flexion assistance. By iteratively detecting knee hyperextension or knee flexion during a stance phase and adjusting the amplitude, timing and/or the duration of the flexion assistance based on the detecting, the resulting individualized flexion assistance is advantageously finely tuned to the characteristics and needs of the user.

While described in the previous embodiment in a manner that may be understood as an iterative process with consecutive steps, the methods of the disclosure may be applied in real-time for correcting an assistance profile by determining a second, a third, a fourth, a fifth or any other flexion assistance by increasing or decreasing the amplitude of the flexion assistance, by adjusting the timing of the flexion assistance, and/or by adjusting the duration of the flexion assistance within a single gait cycle. For example, knee sensor may be provided for obtaining real-time measurements of the knee joint, such that the flexion assistance applied may be fine-tuned or adjusted in real-time during the gait cycle, with no asynchronous observation and correction.

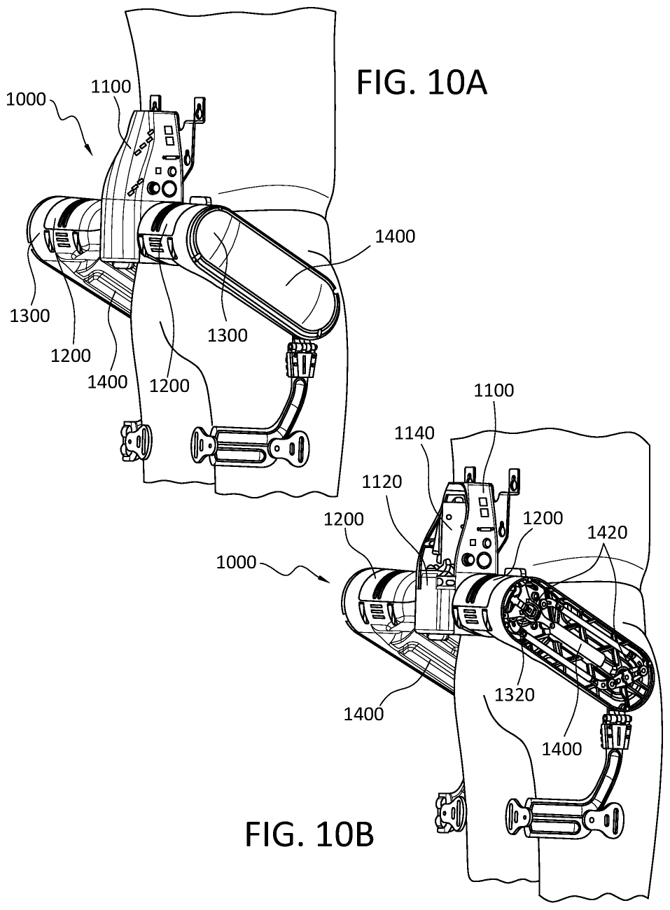

As shown in FIGS. 10a and 10b, an exemplary system for correcting knee hyperextension according to the disclosure may include a wearable robot or robotic exoskeleton, such as an active pelvis orthosis (APO) 1000 having an actuation system arranged to assist bilateral hip flexion/extension movements transmitted by first and second leg units 1400. An exemplary APO is found in U.S. patent application publication 2017/0367919, published Dec. 28, 2017, and incorporated herein by reference. The APO 1000 may include a trunk 1100 from which actuation devices 1200 of the actuation system extend to first and second hip joints 1300 having at least one sensor 1320 and corresponding to the first and second leg units 1400.

The APO 1000 forms a wearable frame by at least the trunk 1100, first and second hip joints 1300, and the first and second leg units 1400. The manner by which the APO secures to the trunk and/or waist of a user, as well as legs of a user may be conventional means common to APOs, including belts, cuffs, straps and other supplementary securing elements common in the orthopedic arts. An example of an interface for an APO, although non-limitative to this disclosure, is described in U.S. Pat. No. 11,000,439, issued on May 11, 2021, and incorporated herein by reference.

In an embodiment, the at least one sensor 1320 may comprise encoders arranged to measure the hip flexion/extension angle of the first and second leg units 1400 relative to the trunk 1100 at the first and second hip joints 1300. Alternative sensor arrangements are contemplated, including arrangements of on-board sensors connected to the computing unit 1140, off-board sensors (pressure sensors in shoes or treadmills, optic sensors, gait analysis laboratories), etc., as understood by one of ordinary skill in the art for evaluating gait or identifying a knee hyperextension.

The APO preferably includes a power unit 1120 and a computing unit 1140, for example comprising a battery and a processor or system-on-module control board, respectively. According to an embodiment, the power unit 1120 and the computing unit 1140 may be provided in the trunk 1100 of the APO. According to varying embodiments, the trunk 1100 may be secured to a lumbar cuff for fitting to a user and the first and second leg units 1400 may each be secured to a limb cuff or linkage for transferring mechanical power to the user's limbs.

The power unit 1120 is preferably arranged to provide assistive power to the actuation devices 1200 for driving a transmission unit 1420 of the first and second leg units 1400 at the first and second hip joints 1300 based on an assistance profile provided by the computing unit 1140. The assistance profile may include flexion assistance for correcting a user's knee hyperextension, which may be determined by the computing unit 1140 based on input signals provided by the at least sensor 1320 or by a clinician.

The flexion assistance of the assistance profile may be determined according to methods of the disclosure. In embodiments, the computing unit 1140 may be connected to the at least one sensor 1132 for identifying a knee hyperextension or a knee flexion during a stance phase, the computing unit 1140 automatically determining a timing for the flexion assistance, a duration of the flexion assistance, and an amplitude of the flexion assistance for the assistance pattern. Following the determination of the flexion torque, the computing unit 1140 may be configured for controlling the actuation devices 1200 for driving the at least one leg unit 1400 at the hip joints 1300 based on the assistance profile including the flexion assistance.

The computing unit 1140 may be configured for iteratively or constantly monitoring a gait cycle of the user for dynamically adjusting flexion assistance to the user's needs. In varying embodiments, the user's gait cycle may be evaluated, and/or iteratively reevaluated, by a clinician, such as in a gait analysis lab. The clinician may then provide the computing unit 1140 with an assistance profile including the flexion assistance according to the disclosure.

The assistance profile of the disclosure is not limited to the flexion assistance for correcting knee hyperextension and may include additional flexion and/or extension assistance, as contemplated by one skilled in the art. The methods and devices of the disclosure may allow for assisting a plurality of joints from a single location, such as a hip joint, such that assistance at the hip level may correct gait impairments at one or all of a hip, knee or ankle joint.

Additional flexion and/or extension assistance of the assistance profile may be configured to assist in movement and restore functional gait patterns by providing coordinated assistance in the movement of limbs in the gait cycle, outside of flexion assistance correcting knee hyperextension according to the disclosure. For example, the computing unit 1140 may be configured for determining segmentation and/or gait events of a gait cycle of a user based on input from the at least one sensor 1132 and applying an assistive force to a limb of the user according to the first flexion assistance and according to an assistive force for advancing a portion of the limbs in a gait cycle, for example by initiating a swing phase.

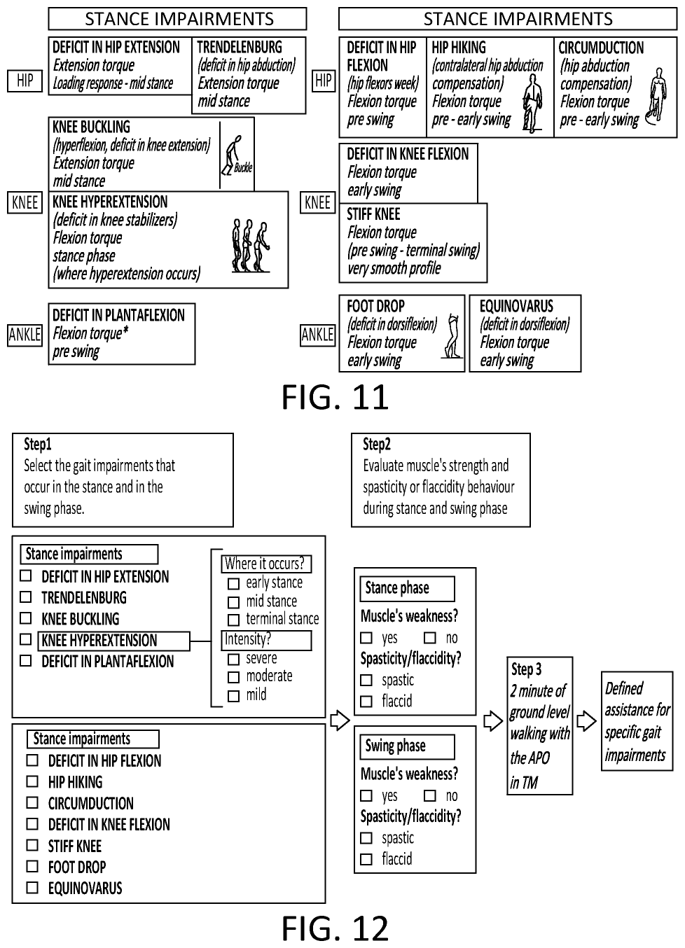

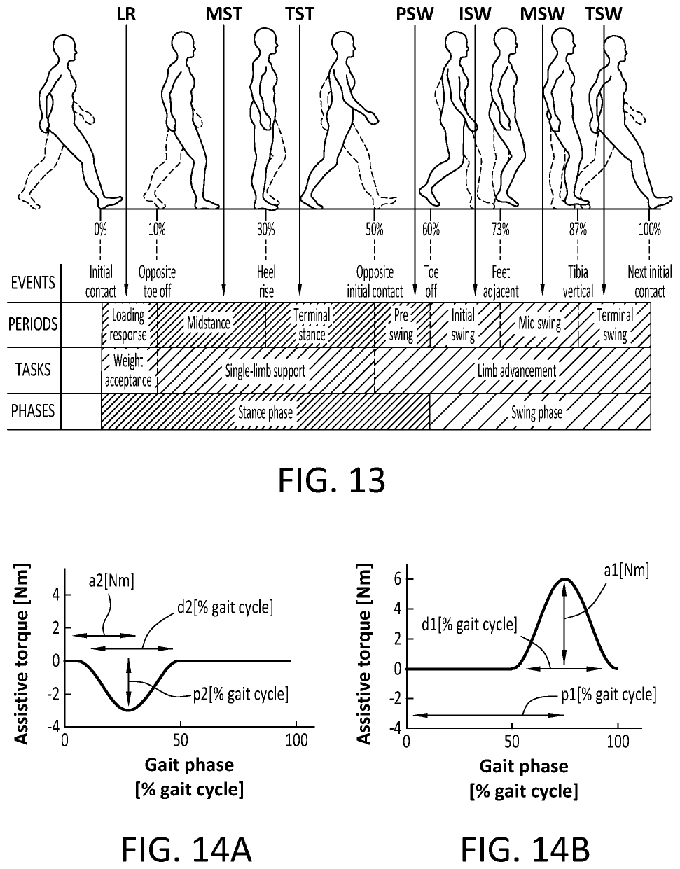

Guidelines for designing assistance for different gait impairments by adapting the disclosed methods and devices for correcting knee hyperextension are illustrated in FIGS. 11-12. In FIG. 11, gait impairments are categorized according to (i) swing/stance phases and (ii) to anatomical joints where the gait impairments occur. Each box represents a gait impairment where the clinical name of the gait impairment is followed by the torque (extension torque for the deficit in hip extension, and knee-buckling; flexion torque for remaining impairments) and the subphase or subphases where the torque should be applied to the hip. FIG. 12 provides a block diagram illustrating the tuning procedure for defining the tailored gait assistance according to specific gait impairments, which may mirror the methods of FIGS. 7 and 9 directed to knee hyperextension. FIG. 13 illustrates the gait cycle's seven subphases: loading response, midstance, terminal stance, pre-swing, initial swing, mid-swing, and terminal swing, as referred to in FIG. 11.

Case Scenario

In a clinic, the physiotherapist uses an APO to treat stroke patients. The intended use of the APO in clinics is to work in mitigating the hip, knee, and ankle gait impairments of the user and to improve the functional outcomes of gait speed and symmetry eventually. A physiotherapist is faced with the challenge of deciding which actions, such as torque provided by the APO at the hip, the APO should provide to obtain positive results.

The APO can communicate with the physiotherapist using terms and concepts that are well known to clinicians. The method for determining the appropriate parameters for usage with the APO are as follows:

A. Identify the gait impairments of the user (through an instrumented gait analysis or a visual analysis) and the levels of spasticity and weakness of the different muscles. Such data may include gait impairments, strength level, spasticity levels, and body weight.

B. Inquire of the user to (i) wear the APO, and (ii) perform 2-3 corridors (at least 10 meters each) in Transparent Mode “TM” (i.e., no assistance and no resistance of the APO) to determine a baseline operation of the APO and a hip angular profile.

C. Use data as inputs of a specific routine that automatically extracts from the data the T-hAP for the user.

D. Provide the suggested T-hAP to the APO to train the user to walk better.

An overview of a system and method is provided. Initially, the list of gait impairments is inputted. This leads to Step 1, which involves selecting assistance primitives on a “Gait Impairments versus Assistance” Taxonomy. An internal Output 1 to Step 1 results in a list of assistance primitives based on the user's gait impairments.

As shown in FIG. 12, the impairments regarding stance may include a deficit in hip extension, deficit in hip abduction, knee buckling, knee hyperextension and deficit in plantarflexion. While considering the stance phase, a determination is made on muscle weakness and spasticity or flaccidity in the stance phase. Impairments regarding swing impairments may include a deficit in hip flexion, hip hiking, circumduction, a deficit in knee flexion, stiff knee, foot drop, or equinovarus. Likewise, there is a determination on muscle weakness and spasticity/flaccidity in the swing phase.

Referring to FIGS. 14A and 14B, the assistance primitives are determined based on gait impairments. For example, in FIG. 14A, first assistance primitive 1 for a deficit in hip abduction may result in the APO being adapted for greater extension torque (a2), particularly in a user's gait cycle subphase in a midstance center, as evidenced by the percentage of the gait cycle.

In FIG. 14B, in a second assistive primitive of a gait impairment of a stiff knee, the APO action may be arranged to provide greater flexion torque (a1) in a user's gait cycle subphase, from pre-swing to late swing phases, as evidenced by the percentage of the gait cycle.

The following list is a provision for the adaptation of the APO according to the following gait impairments versus assistance taxonomy, as illustrated in FIG. 11.

For Stance Impairments:

A deficit in hip extension results in extension torque, with a loading response of mid-stance intersection (LRMSint).

A deficit in hip abduction results in extension torque, with a loading, respond at mid stance center (MSc).

Knee buckling or hyperflexion and a deficit in knee extension result in an extension torque, with a mid stance center (MSc).

Knee hyperextension or a deficit in knee stabilizers results in a flexion torque in a stance phase (where hyperextension occurs).

For the ankle, a deficit in plantarflexion results in flexion torque, in a pre swing center (PSc).

For Swing Impairments:

A deficit in hip flexion occurs when hip flexors are weak results in flexion torque at a pre swing center (PSc).

Hip Hiking occurs when contralateral hip adduction compensation results in flexion torque at a pre early swing intersection (PSESint).

Circumduction or hip abduction compensation results in flexion torque at pre-early swing intersection (PSESint).

A deficit in knee flexion results in flexion torque at an early swing center (Esc).

A stiff results in flexion torque at pre swing—late swing intersection (PSLSint).

Reduced foot clearance, such as foot drop or a deficit in dorsiflexion, results in flexion torque in an early swing center (ESc).

Next there is a hAP provided from the TM of the APO. Step 2 involves the identification of the biomechanical gait cycle sub-phases in the user's TM hAP. Step 2 results in an internal Output 2 of the user's hAP divided among seven gait cycle subphases.

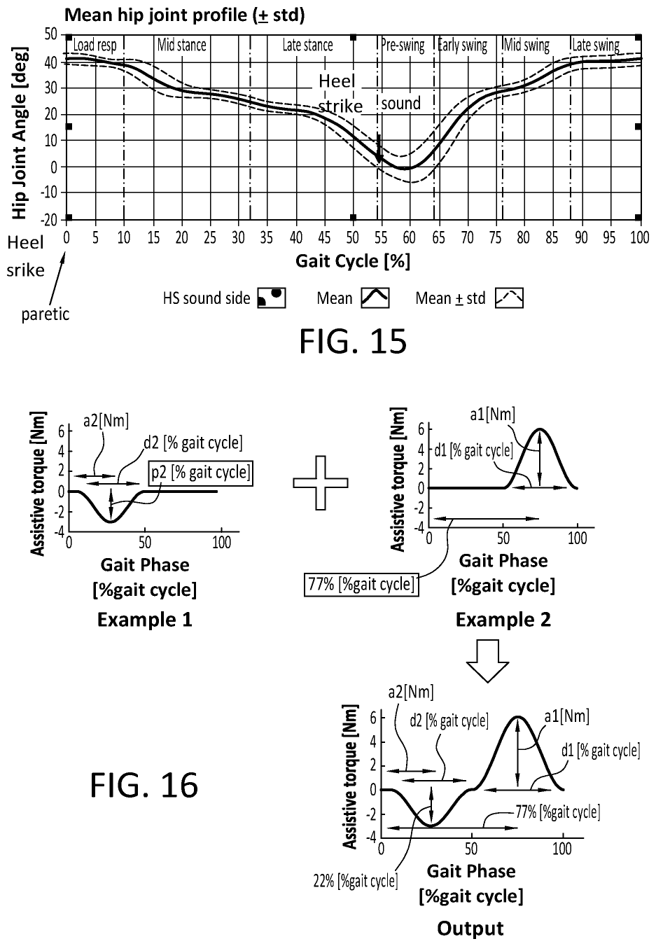

For example, FIG. 15 illustrates the gait cycle versus the hip joint angle in degrees. In this example, the mean and standard deviation of the angular profile of the short walking in TM is plotted along with data to identify the biomechanical gait cycle as a function of the TM hip angular profile. In the illustrated example, the following information is obtained: Stance phase duration (StPD): 54%; Swing phase duration (SwPD): 46%; Loading response-mid stance intersection (LRMSint): 10%; Mid stance center (MSc): 22%; Pre swing center (PSc): 59%; Pre swing Early swing intersection (PSESint): 64%; Early swing center (ESc): 70%; Pre swing—late swing intersection (PSLSint): 77%.

From the hAP, Step 3 involves the adaptation, conversion and/or refitting of the assistance primitive list obtained from Step 1 into the user's gait cycle subphases. Step 3 yields an internal Output 3 of the assistive primitive list expressed in the user's gait cycle subphases. FIG. 16 shows examples 1 and 2 associated with Output 3. In example 1, knowing the assistive primitive of Step 1 of a gait impairment of Trendelenburg (i.e., a deficit in hip abduction) and the APO action of an extension torque in the user's gait cycle subphase of MSc, the data from step 2 are used to identify such extension torque as being used at 22% of the gait cycle. In example 2, knowing the assistive primitive of Step 1 of a gait impairment of a stiff knee, and the APO action of a flexion torque in a user's gait cycle subphase of PSLSint, the data from Step 2 are used to identify such flexion torque at 77% of the gait cycle.

Step 4 involves combining the assistance primitives, with an internal Output 4 of the T-hAP, defined in terms of timing (t). FIG. 16 exemplifies combining the assistive primitives through the weighted sum of the gait impairments for the flexion torque and the extension torque obtained from Step 3 to create an output of T-hAP defined only in terms of timing, with examples 1 and 2 of Step 3 combined for Output 4.

As for spasticity levels, Step 5 includes shaping of the T-hAP in terms of duration, and yields an internal Output 5 described in terms of timing (t) and duration (d). The duration of the assistive torque is based on the clinical evaluation of the spasticity or flaccidity of the paretic limb during the stance/swing phase. The more spastic contractions characterize the limb, the more the hip assistance should be smooth and gentle to avoid eliciting spastic contractions (i.e., the more the assistive duration should be longer). Contrariwise, if the limb is characterized by flaccidity, the duration will be shorter.

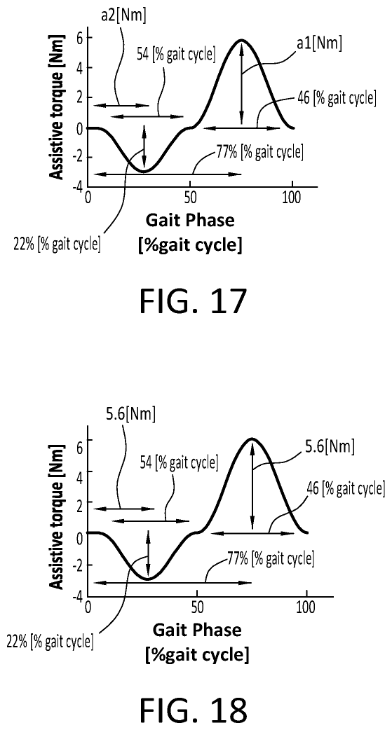

According to FIG. 17, referring to Examples 1 and 2, in Step 2, it was determined that in the stance phase there is spasticity, and spasticity in the swing phase. Consequently, due to determining the overall duration of the gaussian function in stance and swing phases, the stance phase duration (StPD) is determined at 54%, whereas the swing phase duration is determined at 46%. FIG. 17 shows the T-hAP described in terms of timing, from Step 4, and duration from Step 5.

Regarding the strength levels corresponding to the user's body weight, Step 6 comprises the shaping of the T-hAP in terms of amplitude and obtains an internal Output 6 of the T-hAP. The amplitude is determined according to the body mass and muscle weakness level. Regarding stroke patients, it is important to take into account the muscle strength in addition to the body mass of the user.

In determining amplitude, a determination is made on the muscle weakness in the stance phase and the swing phase based on thresholds met concerning the body mass. In the illustrated example of FIG. 18, it is determined that a first threshold 1 is 10% of body mass, and there is muscle weakness. A second threshold is 8% of body mass, and there is no muscle weakness. It is determined that the amplitude is 5.6 Nm for both the first and second amplitudes (a1, a2).

In establishing guidelines for the combination of assistive primitives, the timing of the combination of assistive primitives providing flexion torque, is defined considering the total number of gait impairments requiring flexion torque in each sub-phase and computing a weighted sum, as follows:

$$\frac{{\sum }_{i = 1}^{7} {N}_{i} * i}{{\sum }_{i = 1}^{7} {N}_{i}} ,$$

where Nᵢ is the number of gait impairments requiring flexion assistance in the i-th sub-phase and i=1, . . . , 7 represents the sub-phases, from loading response (i=1) to late swing (i=7). The timing of the combination of assistive primitive provide flexion torque may lead to, for example, be more aligned to the early swing subphase due to the weighted sum.

Likewise, the timing of the combination of assistive primitives providing extension torque, is defined considering the total number of gait impairments requiring extension torque in each sub-phase and computing a weighted sum, as follows:

$$\frac{{\sum }_{i = 1}^{7} {N}_{i} * i}{{\sum }_{i = 1}^{7} {N}_{i}} ,$$

where Nᵢ is the number of gait impairments requiring extension assistance in the i-th sub-phase and i=1, . . . , 7 represents the sub-phases, from loading response (i=1) to late swing (i=7). The timing of the combination of the assistive primitives providing extension torque may lead to, for example, be more aligned to the mid stance subphase due to the weighted sum.

Knee hyperextension is treated separately, as physiotherapists preferably define its timing. The combination of the knee hyperextension primitive with other assistive primitives providing extension torque is not treated using a weighted sum but by prioritization.

It is to be understood that not necessarily all objects or advantages may be achieved under any embodiment or method of the disclosure. Those skilled in the art will recognize that the disclosed wearable robots, systems and methods may be embodied or carried out to achieve or optimize one advantage or group of advantages as taught herein without achieving other objects or advantages as taught or suggested herein.

The skilled artisan will recognize the interchangeability of various disclosed features and methods. Besides the variations described, other known equivalents for each feature and method can be mixed and matched by one of skill in this art to construct a wearable robot under principles of the present disclosure. It will be understood by the skilled artisan that the features described may apply to other types of orthopedic, prosthetic, or medical devices.

1.-30. (canceled)

31. A system for mitigating or correcting knee hyperextension in a user with an assistive lower-limb exoskeleton, wherein the system is arranged:
(a) to identify a first hyperextension in a knee joint of a user's limb during a stance phase of a gait cycle;
(b) to determine a first flexion assistance for an assistance profile based on the first hyperextension of a knee joint by:
(i) determining a timing of the first flexion assistance;
(ii) determining a duration of the first flexion assistance; and
(iii) determining an amplitude of the first flexion assistance;
(c) to apply an assistive flexion torque by the assistive lower-limb exoskeleton to a user's limb during the stance phase according to the first flexion assistance of the assistance profile.

32. The system of claim 31, wherein the system is further arranged to:
(d) identify a second hyperextension or a first flexion in a knee joint of a user's limb during the stance phase of step (c);
(e) adjust the first flexion assistance based on the identification of the second hyperextension or the first flexion in a knee joint to determine a second flexion assistance;
(f) apply an assistive flexion torque to a user's limb during the stance phase according to the second flexion assistance.

33. The system of claim 32, wherein adjustment of the first flexion assistance based on the identification of the second hyperextension or the first flexion in the knee joint to determine a second flexion assistance comprises increasing the amplitude of the second flexion assistance relative to the first flexion assistance in response to identifying the second hyperextension in the knee joint.

34. The system of claim 32, wherein adjustment of the first flexion assistance based on the identification of the second hyperextension or the first flexion in the knee joint to determine a second flexion assistance comprises increasing or decreasing the timing of the second flexion assistance relative to the first flexion assistance in response to identifying the second hyperextension in the knee joint.

35. The system of claim 32, wherein adjustment of the first flexion assistance based on the identification of the second hyperextension or the first flexion in the knee joint to determine a second flexion assistance comprises decreasing the amplitude of the second flexion assistance relative to the first flexion assistance in response to identifying the first flexion in the knee joint.

36. The system of claim 31, wherein timing of the first flexion assistance is within a range of 15% to 40% of the gait cycle.

37. The system of claim 31, wherein the amplitude of the first flexion assistance is within a range of 1.0 N*m to 3.0 N*m.

38. The system of claim 31, wherein timing of the first flexion assistance is aligned with a velocity peak of the gait cycle.

39. The system of claim 31, wherein the assistive flexion torque is arranged to be applied to a user's limb above the knee joint.

40. The system of claim 31, wherein the assistive lower-limb exoskeleton comprises:
a frame arranged to fit about at least one limb;
an actuation system arranged to apply a force to the frame; and
a controller including a processor, the controller arranged to actuate the actuation system at least during a stance phase, at an amplitude, a duration and a timing based on a knee hyperextension of the at least one limb.

41. The system of claim 40, wherein the assistive lower-limb exoskeleton is in communication with at least one sensor arranged to determine at least one gait parameter;
wherein the controller is arranged to determine the amplitude, the duration and the timing based on the at least one gait parameter.

42. An assistive lower-limb exoskeleton for mitigating or correcting knee hyperextension in a user, the assistive lower-limb exoskeleton comprising:
a frame arranged to fit about at least one limb;
an actuation system arranged to apply a force to the frame;
a controller including a processor, the controller arranged to actuate the actuation system at least during a stance phase, at an amplitude, a duration and a timing based on a knee hyperextension of the at least one limb.

43. The assistive lower-limb exoskeleton of claim 42, further comprising at least one sensor arranged to determine at least one gait parameter;
wherein the controller is arranged to determine the amplitude, the duration and the timing based on the at least one gait parameter.

44. A method for mitigating or correcting knee hyperextension in a user, the method comprising:
(a) identifying a first hyperextension in a knee joint of a user's limb during a stance phase of a gait cycle;
(b) determining a first flexion assistance for an assistance profile based on the first hyperextension of a knee joint, said determining comprising:
(i) determining a timing of the first flexion assistance;
(ii) determining a duration of the first flexion assistance; and
(iii) determining an amplitude of the first flexion assistance;
(c) applying an assistive flexion torque to a user's limb during the stance phase according to the first flexion assistance of the assistance profile.

45. The method of claim 44, further comprising the steps of:
(d) identifying a second hyperextension or a first flexion in the knee joint of the user's limb during the stance phase of step (c);
(e) adjusting the first flexion assistance based on the identification of the second hyperextension or the first flexion in the knee joint to determine a second flexion assistance;
(f) applying an assistive flexion torque to the user's limb during the stance phase according to the second flexion assistance.

46. The method of claim 45, wherein the step of adjusting the first flexion assistance based on the identification of the second hyperextension or the first flexion in the knee joint to determine a second flexion assistance comprises increasing the amplitude of the second flexion assistance relative to the first flexion assistance in response to identifying the second hyperextension in the knee joint.

47. The method of claim 45, wherein the step of adjusting the first flexion assistance based on the identification of the second hyperextension or the first flexion in the knee joint to determine a second flexion assistance comprises increasing or decreasing the timing of the second flexion assistance relative to the first flexion assistance in response to identifying the second hyperextension in the knee joint.

48. The method of claim 45, wherein the step of adjusting the first flexion assistance based on the identification of the second hyperextension or the first flexion in the knee joint to determine a second flexion assistance comprises decreasing the amplitude of the second flexion assistance relative to the first flexion assistance in response to identifying the first flexion in the knee joint.

49. The method of claim 44, wherein the timing of the first flexion assistance is within a range of 15% to 40% of the gait cycle, or the amplitude of the first flexion assistance is within a range of 1.0 N*m to 3.0 N*m.

50. The method of claim 44, wherein the assistive flexion torque is applied by an assistive lower-limb exoskeleton comprising:
a frame arranged to fit about at least one limb;
an actuation system arranged to apply a force to the frame; and
a controller including a processor, the controller arranged to actuate the actuation system at least during a stance phase, at an amplitude, a duration and a timing based on a knee hyperextension of the at least one limb.
